(19) United States
(12) Patent Application Publication
(10) Pub. No.: US 2011/0247450 A1
(43) Pub. Date: Oct. 13, 2011

(54) Bicycle Pedal

(76) Inventor: CHING-CHUAN LAI, Taichung City (TW)

(21) Appl. No.: 12/755,593

(22) Filed: Apr. 7, 2010

(51) Int. Cl. B62M 3/08

(52) U.S. Cl. 74/594.4

(57) ABSTRACT

A bicycle pedal contains a central shaft and a body; between a first inner side end of the central shaft and an axial hole of the body being defined a first rotating element; between a first outer side end of the central shaft and the axial hole of the body being defined a second and a third rotating elements, wherein the second and the third rotating elements are a bearing, an inner surface of a first inner loop of and an outer surface of a first outer loop of the second rotating element are limited by a limiting wall of the central shaft and a defining fence of the body respectively; an inner surface of a second outer loop of the third rotating element is limited by the defining fence, a locking nut screwed with the central shaft abuts against a second inner loop of the third rotating element.

### BACKGROUND OF THE INVENTION

1. Field of the Invention

The present invention relates to a bicycle pedal that can lower its weight.

2. Description of the Prior Art

A conventional bicycle pedal 10 as shown in FIG. 1 comprises a central shaft 11, and the central shaft 11 includes a ball bearing 12 installed on an outer side thereof, and an inner loop 121 and an outer loop 122 of the ball bearing 12 are retained with a stepped first limiting wall 111 of the central shaft 11 and a stepped second limiting wall 132 of an axial hole 131 of a body 13 respectively, an outer surface of the ball bearing 12 is retained by a locking nut 14 screwed with outer screws 112 of the central shaft 11 and an end cap 15 screwed with inner screws 133 of the axial hole 131 of the body 13 individually, such that the central shaft 11 and the body 13 are axially limited to rotate in relation to each other.

Because an outer surface of the inner loop 121 is limited by the end cap 15, an outer end of the axial hole 131 of the body 10 has to be further worked to obtain the inner screws 133, screwing with the end cap 15. To obtain the inner screws 113, enough thickness of a peripheral wall of the axial hole 131 on the body 13 has to be maintained that can not lower pedal's weight.

Besides, a receiving space has to be kept on the outer end of the axial hole 131 to screw with the locking nut 14 and the end cap 15, thus increasing weights of the body 13 and the pedal 10.

Since the outer surface of the ball bearing 12 has to match with the locking nut 14 and the end cap 15 to limit the pedal, if one of them becomes loose, a gap between the central shaft 11 and the body 13 is generated to cause crash and vibration, thereby damaging the pedal.

The locking nut 14 is covered by the end cap 15, accordingly the operator can not check and rotate the locking nut 14 directly but has to remove the end cap 15 additionally, having an inconvenient operation.

To lower pedal's weight, a central shaft of the pedal is shorten, but the ball bearing installed on an outer side of the central shaft has to bear more loading weight, causing damage easily.

To solve such a loading problem, an improved pedal 20 has been developed as shown in FIG. 2, wherein a single ball bearing 12 is replaced by two ball bearings 21 arranged side by side, e.g., side walls between an inner loop 211 and an outer loop 212 of the ball bearings 21 are contacted with each other to enhance loading capability; however, such arrangement can not overcome above-mentioned other problems.

The present invention has arisen to mitigate and/or obviate the afore-described disadvantages.

### SUMMARY OF THE INVENTION

The primary object of the present invention is to provide a bicycle pedal which is capable of overcoming the shortcomings of the conventional shower faucet thereof.

Further object of the present invention is to provide a bicycle pedal that can lower weight and working cost and simplify manufacturing process.

Another object of the present invention is to provide a bicycle pedal that the locking nut is fixed on an outer side of the body without installing a conventional end cap, therefore the operator can check whether the locking nut is rotated tightly or not directly, accelerating operating process. Moreover, such a single locking element can diminish crash and vibration between the body and the central shaft to prolong service life of the pedal.

To obtain the above objectives, a bicycle pedal provided by the present invention comprises

a central shaft including a first inner side end and a first outer side end, and the first outer side end including outer screws in which a limiting wall is formed;

a body including an axial hole disposed on an interior thereof, and the axial hole including a second inner side end and a second outer side end, and the axial hole includes a defining fence radially extending from an inner surface thereof adjacent to the second outer side end;

a first rotating element installed between the first inner side end of the central shaft and the second inner side of the axial hole so that the second inner side end of the body rotates axially relative to the first inner side end of the central shaft by using the first rotating element;

a second rotating element installed between the first outer side end of the central shaft and the second outer side end of the axial hole of the body, wherein the second rotating element is a bearing and includes a first outer loop and a first inner loop to rotate relative to the first outer loop, and an inner surface of the first inner loop and an outer surface of the first outer loop are limited by the limiting wall of the central shaft and the defining fence of the body respectively;

a third rotating element installed between the first outer side end of the central shaft and the second outer side end of the axial hole of the body, wherein the third rotating element is a bearing and is provided with a second outer loop and a second inner loop to rotate relative to the second outer loop, an inner surface of the second outer loop is limited by the defining fence of the body;

a locking nut screwed with the outer screws of the first outer side end to abut against an outer surface of the second inner loop of the third rotating element.

### BRIEF DESCRIPTION OF THE DRAWINGS

FIG. 1 is a cross sectional view showing a conventional bicycle pedal;

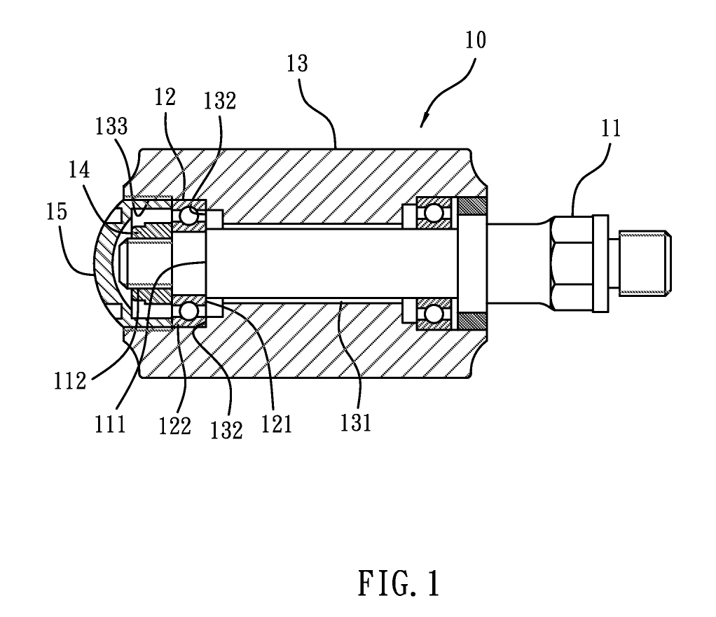

FIG. 2 is a cross sectional view showing another conventional bicycle pedal;

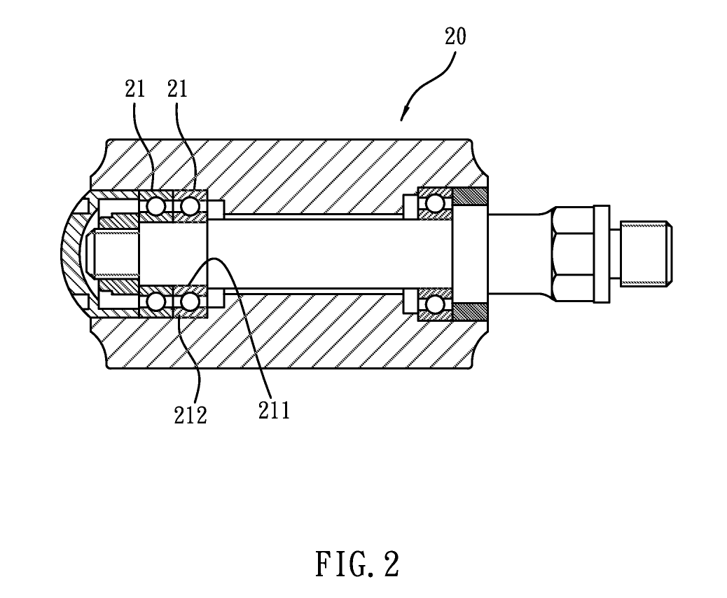

FIG. 3 is a perspective view showing the assembly of a bicycle pedal in accordance with a preferred embodiment of the present invention;

FIG. 4 is a perspective view showing the exploded components of the bicycle pedal in accordance with the preferred embodiment of the present invention;

FIG. 5 is a side cross sectional view showing the assembly of the bicycle pedal in accordance with the preferred embodiment of the present invention;

FIG. 6 is an amplified cross sectional view showing the assembly of a part of the bicycle pedal in accordance with the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

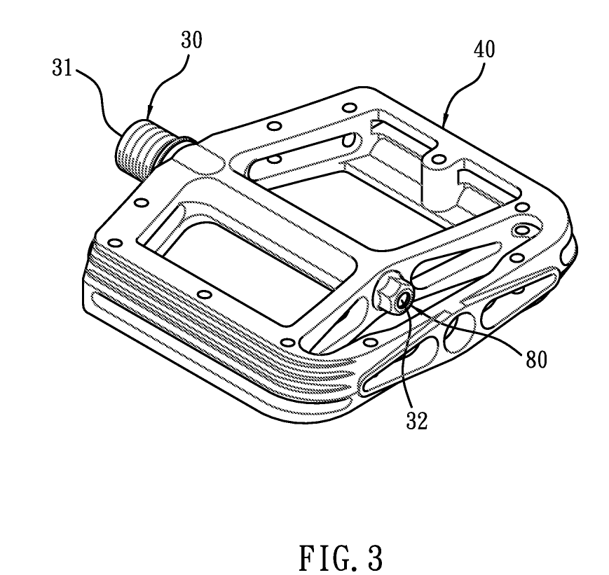

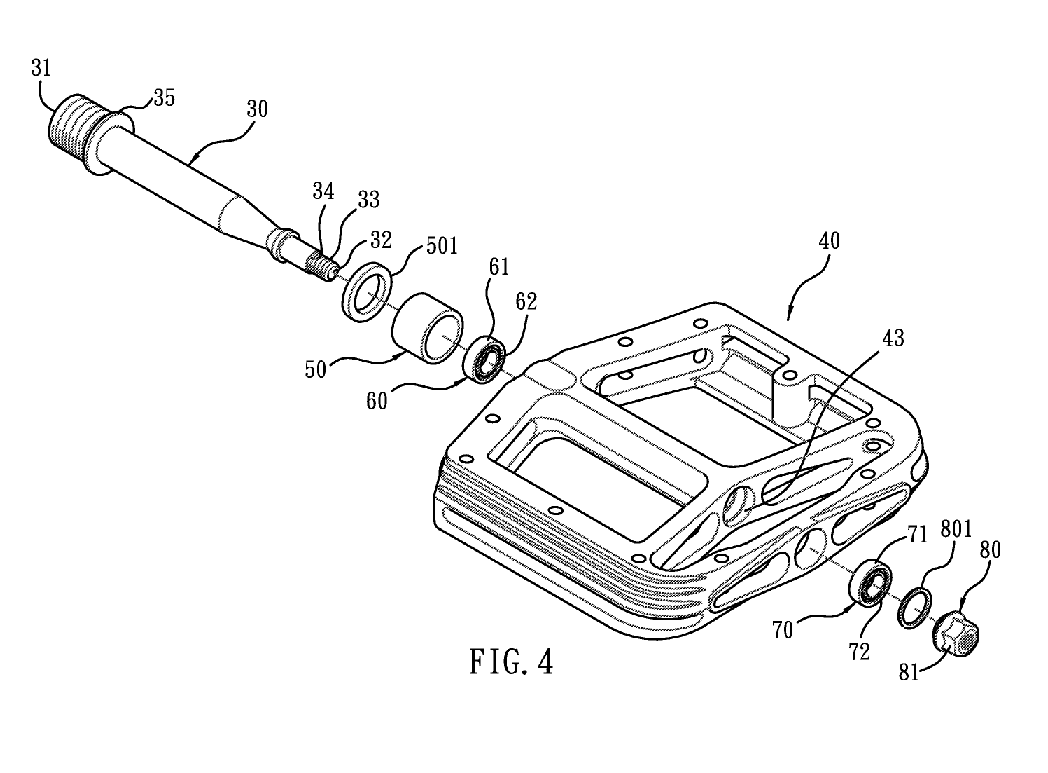

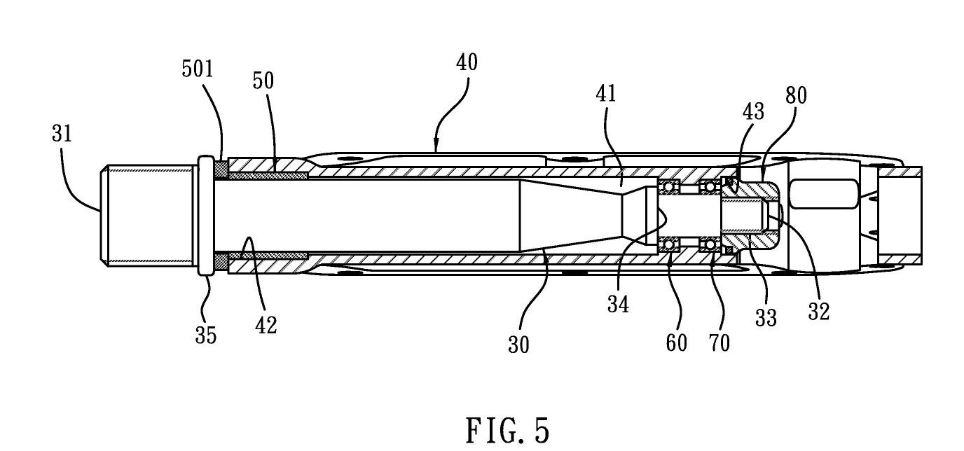

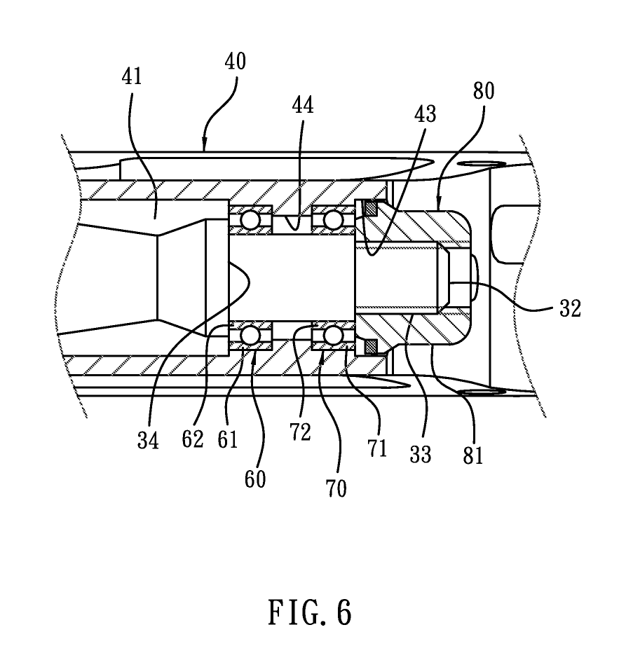

Referring to FIGS. 3-6, a bicycle pedal according to a preferred embodiment of the present invention comprises a central shaft 30, a body 40, a first rotating element 50, a second rotating element 60, a third rotating element 70, and a locking nut 80.

The central shaft 30 includes a first inner side end 31 and a first outer side end 32, and the first outer side end 32 includes outer screws 33 in which a limiting wall 34 is formed.

The body 40 includes an axial hole 41 disposed on an interior thereof, and the axial hole 41 includes a second inner side end 42 and a second outer side end 43, and the axial hole 41 includes a defining fence 44 radially extending from an inner surface thereof adjacent to the second outer side end 43.

The first rotating element 50 is installed between the first inner side end 31 of the central shaft 30 and the second inner side 42 of the axial hole 41 so that the second inner side end 42 of the body 40 rotates axially relative to the first inner side end 31 of the central shaft 30 by using the first rotating element 50. In this embodiment, the first rotating element 50 is an oilless bearing formed in a sleeve shape or a ball bearing.

The first rotating element 50 is provided with a first dustproof cover 501 to be fitted to an inner side of the central shaft 30 and engaged between a positioning shoulder 35 which integrally extends on the inner side of the central shaft 30 and an inner side of the body 40 so that the first rotating element 50 is covered to obtain a dustproof effect.

The second rotating element 60 is installed between the first outer side end 32 of the central shaft 30 and the second outer side end 43 of the axial hole 41 of the body 40. In the embodiment, the second rotating element 60 is a ball bearing, a needle roller bearing, or other suitable bearings. The ball bearing includes a first outer loop 61 and a first inner loop 62 to rotate relative to the first outer loop 61, and an inner surface of the first inner loop 62 and an outer surface of the first outer loop 61 are limited by the limiting wall 34 of the central shaft 30 and the defining fence 44 of the body 40 respectively.

The third rotating element 70 is installed between the first outer side end 32 of the central shaft 30 and the second outer side end 43 of the axial hole 41 of the body 40. In this embodiment, the third rotating element 70 is a ball bearing, a needle roller bearing, or other suitable bearings. The ball bearing is provided with a second outer loop 71 and a second inner loop 72 to rotate relative to the second outer loop 71, an inner surface of the second outer loop 71 is limited by the defining fence 44 of the body 40.

The locking nut 80 is screwed with the outer screws 33 of the first outer side end 32 to abut against an outer surface of the second inner loop 72 of the third rotating element 70.

The locking nut 80 includes a second dustproof cover 801 fitted on an outer surface thereof, and an outer surface of the second dustproof cover 801 is closed to or in contact with the axial hole 41 so that the second and third rotating elements 60, 70 are covered to achieve a dustproof effect.

The locking nut 80 further includes a predetermined tool fixed on the outer surface thereof, such as a moveable wrench, box wrench, open end wrench, so as to rotate a turning portion 81 which is located at an outer side of the second dustproof cover 801, and when the locking nut 80 is locked securely, the turning portion 81 extends out of the axial hole 41 of the second outer side end 43 of the body 40 to operate the tool easily.

An outer end portion of the axial hole 41 of the body 40 has not to be worked to obtain a conventional outer screwing section and screwing cover, thus enabling to simplify manufacturing process and lower working cost. And a thickness of a peripheral wall of the axial hole 41 is decreased, a small size space is formed on the second outer side end 43 of the axial hole 41 to screw with the locking nut 80 so that a length of the axial hole 41 is lowered to decrease a weight of the body 40.

The second and third rotating elements 60, 70 are used to enhance loading capacity, therefore the central shaft 30 is shorten but still have strong loading capacity. Likewise, the length of the axial hole 41 of the body 40 is lowered to lessen a weight of the pedal.

The locking nut 80 is fixed on an outer side of the body 40 without installing a conventional end cap, therefore the operator can check whether the locking nut 80 is rotated tightly or not directly, accelerating operating process. Moreover, such a single locking element can diminish crash and vibration between the body 40 and the central shaft 30 to prolong service life of the pedal.

While we have shown and described various embodiments in accordance with the present invention, it is clear to those skilled in the art that further embodiments may be made without departing from the scope of the present invention.

What is claimed is:

1. A bicycle pedal comprising
a central shaft including a first inner side end and a first outer side end, and the first outer side end including outer screws in which a limiting wall is formed;
a body including an axial hole disposed on an interior thereof, and the axial hole including a second inner side end and a second outer side end, and the axial hole includes a defining fence radially extending from an inner surface thereof adjacent to the second outer side end;
a first rotating element installed between the first inner side end of the central shaft and the second inner side of the axial hole so that the second inner side end of the body rotates axially relative to the first inner side end of the central shaft by using the first rotating element;
a second rotating element installed between the first outer side end of the central shaft and the second outer side end of the axial hole of the body, wherein the second rotating element is a bearing and includes a first outer loop and a first inner loop to rotate relative to the first outer loop, and an inner surface of the first inner loop and an outer surface of the first outer loop are limited by the limiting wall of the central shaft and the defining fence of the body respectively;
a third rotating element installed between the first outer side end of the central shaft and the second outer side end of the axial hole of the body, wherein the third rotating element is a bearing and is provided with a second outer loop and a second inner loop to rotate relative to the second outer loop, an inner surface of the second outer loop is limited by the defining fence of the body;
a locking nut screwed with the outer screws of the first outer side end to abut against an outer surface of the second inner loop of the third rotating element.

2. The bicycle pedal as claimed in claim 1, wherein the first rotating element is an oilless bearing.

3. The bicycle pedal as claimed in claim 1, wherein the first rotating element is a ball bearing.

4. The bicycle pedal as claimed in claim 1, wherein the second rotating element is a ball bearing.

5. The bicycle pedal as claimed in claim 1, wherein the third rotating element is a ball bearing.

6. The bicycle pedal as claimed in claim 1, wherein the locking nut includes a second dustproof cover fitted on an outer surface thereof, and an outer surface of the second dustproof cover is closed to or in contact with the axial hole.

7. The bicycle pedal as claimed in claim 1, wherein the locking nut includes a turning portion located at an outer side thereof to rotate a predetermined tool, and the turning portion extends out of the axial hole of the second outer side end of the body.
